(19) United States
(12) Patent Application Publication
(10) Pub. No.: US 2014/0158230 A1
(43) Pub. Date: Jun. 12, 2014

(54) LIQUID DRIP PREVENTION VALVE

(71) Applicants: Kazuhiro Sugata, Kasugai-shi (JP); Takehito Nakagaki, Nagoya-shi (JP); Michio Miyashita, Seto-shi (JP)

(72) Inventors: Kazuhiro Sugata, Kasugai-shi (JP); Takehito Nakagaki, Nagoya-shi (JP); Michio Miyashita, Seto-shi (JP)

(73) Assignee: CKD CORPORATION, Komaki-shi, Aichi (JP)

(21) Appl. No.: 14/233,278

(22) PCT Filed: Aug. 20, 2012
(86) PCT No.: PCT/JP2012/070979

§ 371 Date: Jan. 16, 2014

(30) Foreign Application Priority Data
Aug. 23, 2011 (JP) 2011-181980

(51) Int. Cl. F16K 23/00; F16K 15/18; F16K 17/04

(52) U.S. Cl. CPC F16K 23/00; F16K 17/048; F16K 15/185
USPC 137/537; 251/175

(57) ABSTRACT

In a liquid drip prevention valve, an input port is formed in the upper face of a flow passage block, and an output port is formed in the lower face, which opposes the upper face of the flow passage block. In addition, a valve chamber is formed on a side face of the flow passage block, and an air block abuts the side face. Furthermore, a diaphragm valve makes contact with a valve seat when pressure is applied with respect to a back side chamber of the diaphragm valve and separates from the valve seat when the back side chamber is brought to negative pressure, thus forming the liquid drip prevention valve.

### TECHNICAL FIELD

The present invention relates to a liquid drip prevention valve to be used in a single wafer cleaning process in a semiconductor manufacturing apparatus.

### BACKGROUND ART

A cleaning process of a semiconductor manufacturing apparatus includes batch cleaning and single wafer cleaning. The single wafer cleaning has been increasingly used in recent years because this manner is suitable for increased size of semiconductor wafers, miniaturized chips, multi-stratified wiring, and others, and imposes less environmental burden with respect to liquid waste disposal. The single wafer cleaning is a method for cleaning semiconductor wafers one by one by applying a chemical liquid there to from a nozzle and thus needs to prevent liquid dripping phenomenon that the liquid drips off from a tip of the nozzle every time cleaning. To avoid such a defect, for example, Patent Documents 1 and 2 disclose techniques for preventing liquid dripping.

The technique of Patent Document 1 includes a discharge valve 300 to be closed by a return spring 600 to block off a liquid discharge passage 200 communicated with an output nozzle 500 and an inner chamber 400 communicated with the output nozzle 500 as shown in FIGS. 14 and 15. In order to suck back a liquid from the output nozzle 500 after the discharge valve 300 is closed, a part 301 of the discharge valve is caused to enter in the discharge passage 200 by the return spring 600 to thereby increase the volume of the inner chamber 400.

The technique of Patent Document 2 is a chemical liquid valve placed on a flow passage through which a fluid flows and arranged to move a diaphragm valve into or out of contact with a valve seat to thereby control supply of the fluid, the chemical liquid valve includes a diaphragm valve for suck back which is operated in sync with the diaphragm valve.

Liquid dripping from a nozzle also depends on the surface tension of a chemical liquid. For instance, a chemical liquid having a large surface tension is high in viscosity and thus is unapt to cut a liquid even after the valve is closed. This also results in a tendency to cause liquid dripping. On the contrary, a chemical liquid having a small surface tension is cut off at the instant when the valve is closed, but air bubbles may enter in the liquid by pressure of atmosphere. If air bubbles are mixed in the chemical liquid in the tip of the nozzle, the chemical liquid is not uniformly applied to a wafer, leading to an uneven cleaning result. The liquid below the air bubbles is not sucked in the nozzle and thus is liable to drip.

To solve the above air bubble problem and liquid dripping problem, for example, Patent Document 3 discloses a technique related to a discharge nozzle in which a number of hole fibers having a number of microscopic holes on each outer surface and having a predetermined length and a small inner diameter are bundled with gaps provided between the fibers and accommodated in a housing.

### RELATED ART DOCUMENTS

### Patent Documents

Patent Document 1: JP-A-58(1983)-28072

Patent Document 2: JP-A-2003-278927

Patent Document 3: JP-A-2000-124126

### SUMMARY OF INVENTION

### Problems to be Solved by the Invention

However, the techniques disclosed in Patent Documents 1 to 3 have the following problems. In the technique of Patent Document 1, after the discharge valve 300 is closed by the return spring 600, the part 301 of the valve body is caused to enter in the liquid discharge passage 200 against liquid pressure to increase the volume of the inner chamber, thereby enabling sucking back of the liquid from the nozzle 50. However, if the urging or biasing force of the return spring 600 is too large as compared with the liquid pressure, the discharge valve 300 may not be subsequently moved to an open position. Therefore, the spring urging force of the return spring 600 acting in a valve closing direction has to be set small. This tends to slow a valve closing speed of the discharge valve 300 and decrease impact (water hammer) that will transmit through the liquid in the nozzle 500 when the valve is closed. Small water hammer at the valve closing time causes a problem that liquid cutting utilizing the inertia force is not appropriately performed at the nozzle tip. Unless the liquid is appropriately cut off at nozzle tip at the time of valve closing, liquid dripping could not be reliably prevented even when suction is subsequently performed.

Furthermore, the technique of Patent Document 1 provides the configuration that makes the part 301 of the valve body enter in the liquid discharge passage 200 to increase the volume of the inner chamber. Thus, the part 301 needs to be configured to slide in contact with the inner wall of the liquid discharge passage 200. Accordingly, the configuration of the valve body becomes completed and working accuracy has to be enhanced, which is likely to cause a problem with an increase in apparatus cost.

In the technique of Patent Document 1, the liquid passes through between spiral portions of the return spring 600, which is likely to cause turbulent flow. To make the turbulent flow back into laminar flow, it is necessary to design the nozzle inner flow passage from the end of the inner chamber on which the return spring 600 abuts to the nozzle tip to have a predetermined length or more. This results in an increased size of the valve apparatus in an axial direction and thus in difficulty in reducing the valve size.

In the technique of Patent Document 2, the diaphragm valve for suck back is provided to operate in sync with the diaphragm valve, enabling sucking back of the chemical liquid at the same time when the valve body is closed. Accordingly, liquid cutting at the nozzle tip at the time of valve closing is more appropriately performed than in the technique of Patent Document 1. However, since a suck back circuit is provided separately from a circuit for supplying the chemical liquid, the whole valve is increased in size and thus in weight, which are contrary to a demand for size and weight reduction of the valve.

In the technique of Patent Document 3, furthermore, a filling rate of hole fibers has to be set to on the order of 30% to 60% (see paragraph [0016]). To allow a predetermined amount of the liquid to flow, the housing diameter has to be increased. This causes a problem with difficulty in addressing a demand for valve size and weight reduction.

The present invention has been made to solve the above problems and has a purpose to provide a liquid drip prevention valve with reduced size and weight capable of easily controlling liquid cutting at the time of valve closing and facilitating formation of laminar flow.

### Means of Solving the Problems

To achieve the above purpose, a liquid drip prevention valve in one aspect of the invention provides the following configurations.

(1) In a liquid drip prevention valve comprising: a flow passage block including an input passage, an output passage, and a valve chamber with which the input passage and the output passage are communicated, the flow passage block being formed with a valve seat around a valve hole communicated with the output passage in the valve chamber; an air block formed with an airflow passage; and a diaphragm valve fixed between the flow passage block and the air block to move into or out of contact with the valve seat, the flow passage block is formed, on an upper face, with an input port communicated with the input passage, the flow passage block is formed, on a lower face opposite the upper face, with an output port communicated with the output passage, the valve chamber is formed in a side face of the flow passage block and the air block is in contact with the side face, and the diaphragm valve will come into contact with the valve seat when a back side chamber of the diaphragm valve is pressurized and will separate from the valve seat when the back side chamber is subjected to negative pressure.

With the above configuration, a liquid drip prevention valve with reduced size and reduced weight can be provided. Since separating the diaphragm valve from the valve seat is achieved by the negative pressure, the number of components needed for valve opening can be reduced. Thus, the liquid drip prevention valve can be configured by three components, i.e., the flow passage block, the air block, and the diaphragm valve, so that the number of components can be reduced, thus enabling size reduction and weight reduction.

Because of the reduced number of components and the simplified configuration, it is possible to reliably prevent liquid dripping. To be concrete, since a simple configuration that places the diaphragm valve into contact with the valve seat can prevent liquid dripping, the sealing strength ensured between the diaphragm valve and the valve seat can surely prevent liquid dripping. Furthermore, the output passage formed in a linear shape makes it easy to form the fluid into laminar flow.

(2) In the liquid drip prevention valve described in (1), preferably, a diaphragm escape groove is formed around the valve seat, the diaphragm escape groove is formed in an annular form around the valve hole, and a valve chamber communication port is formed in the diaphragm escape groove to provide communication between the input passage and the valve chamber.

With the above configuration, the diaphragm valve can be placed in contact with the valve seat over the entire circumference by uniform stress. Thus, the sealing strength can be maintained uniformly over the entire circumference of the valve seat, thereby enabling reliably preventing liquid dripping.

To be concrete, in a case where no diaphragm escape groove is formed, when a diaphragm valve is pressurized from a back side chamber, the diaphragm valve becomes pressed against a valve chamber communication port which is a space. Accordingly, only a portion of the diaphragm valve contacting with the valve chamber communication port is depressed. When the shape of a part of the diaphragm valve is thus changed, a contact portion of the diaphragm valve contacting with the valve seat is displaced. In the case where no diaphragm escape groove is formed, consequently, the diaphragm valve displaced with respect to the valve seat cannot contact therewith by uniform stress over the entire circumference. Accordingly, the sealing strength becomes nonuniform over the entire circumference of the valve seat, generating some weak sealed portions. This may cause leakage of a fluid from the weak sealed portions and thus liquid dripping cannot be surely prevented.

On the contrary, when the diaphragm escape groove is formed in an annular form extending over the entire circumference, the shape of the diaphragm valve is also changed uniformly over the entire circumference as with the shape of the diaphragm escape groove. This uniform change in shape over the entire circumference can prevent displacement between contact faces of the diaphragm valve and the valve seat. Accordingly, the diaphragm valve can be placed in contact with the valve seat over the entire circumference by the uniform stress, thereby enabling reliably preventing liquid dripping. Furthermore, a fluid staying in the diaphragm escape groove at the valve opening time will be of help to push up the diaphragm valve in a valve opening direction. Thus, the presence of the diaphragm escape groove enables valve opening under a small negative pressure.

(3) In the liquid drip prevention valve described in (2), preferably, the diaphragm escape groove has a depth so that a web portion of the diaphragm valve will not contact with a bottom of the diaphragm escape groove when the diaphragm valve is placed into contact with the valve seat.

With the above configuration, the sealing strength between the diaphragm valve and the valve seat can be maintained. To be concrete, the depth of the diaphragm escape groove is preferred to be shallow because the shallow diaphragm escape groove is small in volume and therefore a fluid staying in the diaphragm escape groove is reduced, resulting in a reduction in the amount of the fluid caused to move when the diaphragm valve presses the diaphragm escape groove. As the fluid moves from the diaphragm escape groove toward the valve seat, it generates a force in a direction to push up the diaphragm valve. If the diaphragm valve is pushed up, the sealing strength is weakened, which is problematic. Furthermore, pressurizing is required to increase the sealing strength by just that much, leading to a problem that the energy to be used has to be increased. Therefore, the volume of the diaphragm escape groove is reduced to decrease the moving amount of the fluid, thereby reducing an amount of the fluid leaking to the diaphragm valve. This enables maintaining the sealing strength between the diaphragm valve and the valve seat.

(4) In the liquid drip prevention valve described in (2) or (3), preferably, the diaphragm escape groove is formed between a center-side protrusion formed in an annular form around the valve seat and an outer-circumferential-side protrusion formed in an annular form, and the center-side protrusion is lower than the valve seat face.

With the above configuration, the diaphragm valve can enhance the stress to press the valve seat because the valve body portion of the diaphragm valve comes into contact with the valve seat and then the web portion pulls the valve body portion. As the web portion pulls the valve body portion, the stress on the valve body portion can be enhanced. This can enhance the stress and increase the sealing strength.

(5) In the liquid drip prevention valve described in one of (2) to (4), preferably, the diaphragm escape groove is formed so that the diaphragm valve is allowed to contact with the valve seat over an entire circumference by uniform stress.

With the above configuration, the diaphragm valve is allowed to contact with the valve seat over an entire circumference by uniform stress. Thus, turbulent flow can be converted into laminar flow. To be concrete, the number of components can be reduced and the configuration can be simplified, so that the output passage can be made in proximity to the valve hole. Since the output passage can be arranged in proximity to the valve hole, the liquid drip prevention valve can be reduced in size and further the fluid can be changed into laminar flow.

(6) In the liquid drip prevention valve described in one of (1) to (5), preferably, the input passage, the output passage, and the valve chamber are made of a chemical-resistant material or are coated by a chemical-resistant material.

With the above configuration, the chemical-resistance can be enhanced. Thus, the fluid is allowed to flow out without causing contamination.

(7) In the liquid drip prevention valve described in one of (1) to (6), preferably, the output passage has a length enough to obtain laminar flow of the fluid in the output port.

With the above configuration, the turbulent flow can be changed into laminar flow. To be concrete, the number of components can be reduced and the configuration can be simplified, thereby enabling arranging the output passage in proximity to the valve hole. Since the output passage is arranged in proximity to the valve hole, the liquid drip prevention valve can be reduced in size and the fluid can be made into laminar flow.

(8) In the liquid drip prevention valve described in one of (1) to (7), preferably, the output port is formed in an output nozzle.

The above configuration enables adjustment of the length of the output passage by the length of the nozzle. Thus, the weight reduction of the entire liquid drip prevention valve can be achieved.

(9) Preferably, the liquid drip prevention valve described in one of (1) to (8) will be placed on a manifold base.

With the above configuration, space saving can be achieved. Further, the liquid drip prevention valve can be installed in a retrofit manner on the manifold base and thus replacement is easy.

(10) In the liquid drip prevention valve described in one of (1) to (8), preferably, the flow passage block includes a plurality of input passages, a plurality of output passages, a plurality of valve chambers, a plurality of valve holes, and a plurality of valve seats, the air block includes a plurality of airflow passages, and a plurality of the diaphragm valve bodies are provided in correspondence to the plurality of valve seats.

With the above configuration, the liquid drip prevention valve can be configured as a manifold form. This manifold form enables space saving while providing the inherent operations and effects of the liquid drip prevention valve.

### Effects of the Invention

According to the invention, it is possible to provide a compact and light liquid drip prevention valve capable of easily controlling liquid cutting at the valve closing time and facilitating formation of laminar flow.

### BRIEF DESCRIPTION OF THE DRAWINGS

FIG. 1 is a front view of a liquid drip prevention valve in an embodiment according to the invention;

FIG. 2 is a cross sectional view of the liquid drip prevention valve (a valve open state) taken along a line II-II in FIG. 1;

FIG. 3 is another cross sectional view of the liquid drip prevention valve (a valve closed state) taken along the line II-II in FIG. 1;

FIG. 4 is a bottom view of the liquid drip prevention valve in the embodiment according to the invention;

FIG. 5 is a top view of the liquid drip prevention valve in the embodiment according to the invention;

FIG. 6 is an enlarged view of a part indicated by a chain line P in the liquid drip prevention valve (the valve closed state shown in FIG. 3;

FIG. 7 is a perspective cross sectional view of a flow passage block according to the invention;

FIG. 8 is a stress distribution diagram of stress on a valve seat and its surrounding area when a valve chamber of the liquid drip prevention valve (valve closing) according to the invention is seen from a side of an air block;

FIG. 9 is a stress distribution diagram of stress on the valve seat and its surrounding area when a valve chamber of a liquid drip prevention valve (valve closing) formed with no diaphragm escape groove is seen from a side of an air block;

FIG. 10 is a stress distribution diagram of stress on the diaphragm valve of the liquid drip prevention valve (valve closing) according to the invention;

FIG. 11 is a stress distribution diagram of stress on the diaphragm valve of the liquid drip prevention valve (valve closing) formed with no diaphragm escape groove;

FIG. 12 is a diagram showing a relationship between operating pressure and fluid pressure in the liquid drip prevention valve according to the invention;

FIG. 13 is a flow line diagram in the liquid drip prevention valve shown in FIG. 2;

FIG. 14 is a cross sectional view of a conventional liquid drip prevention valve (valve opening); and

FIG. 15 is another cross sectional view of the conventional liquid drip prevention valve (valve closing).

### MODE FOR CARRYING OUT THE INVENTION

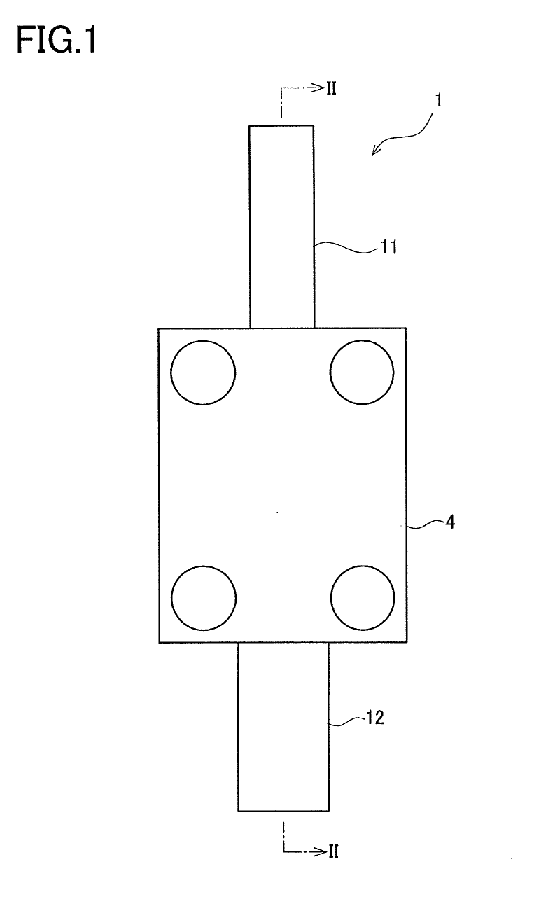

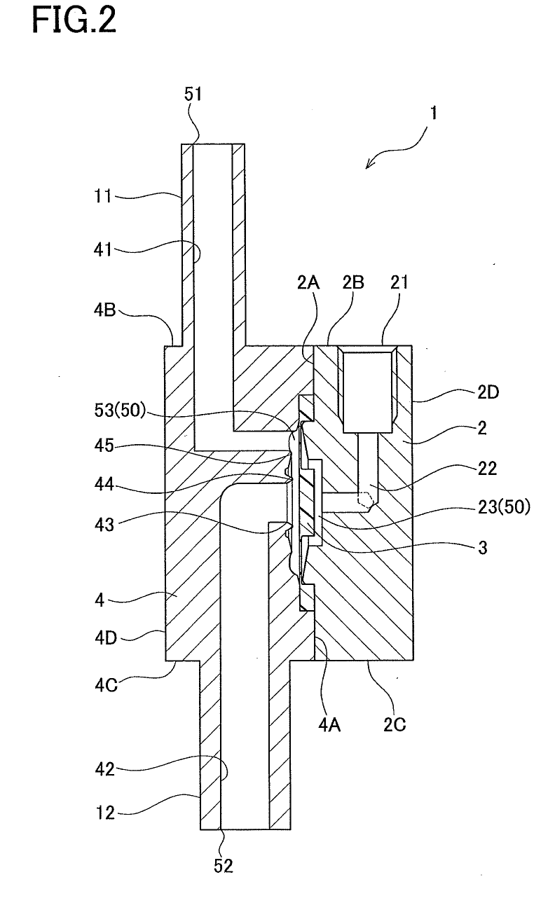

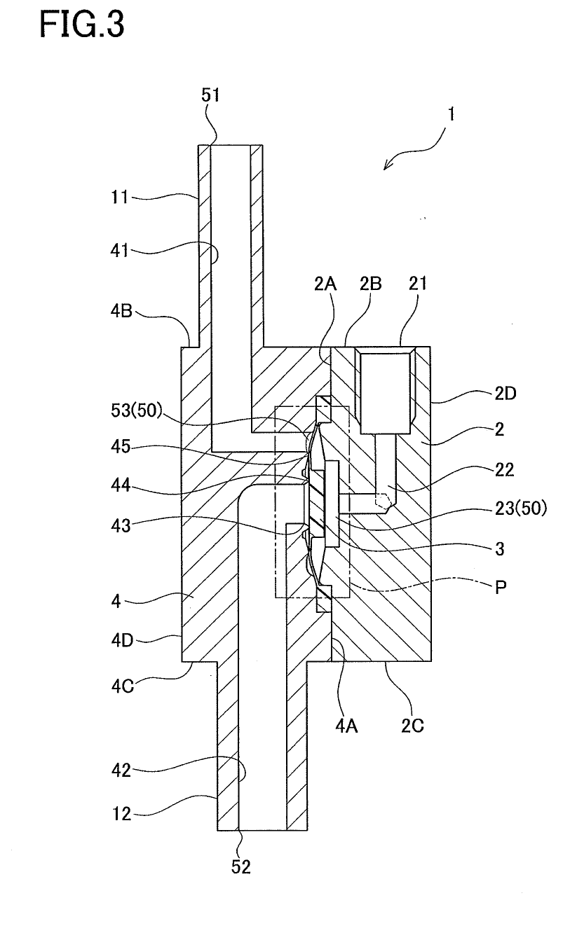

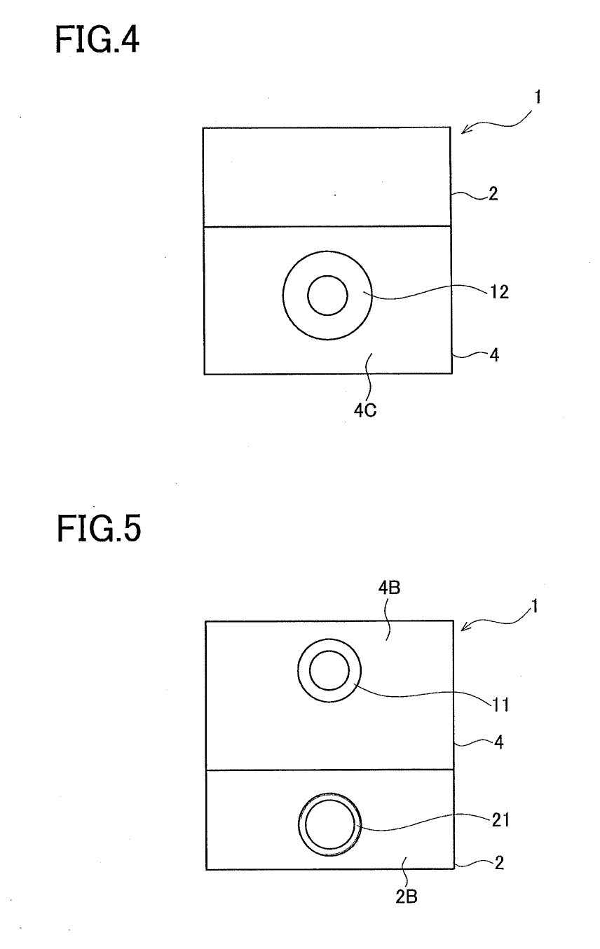

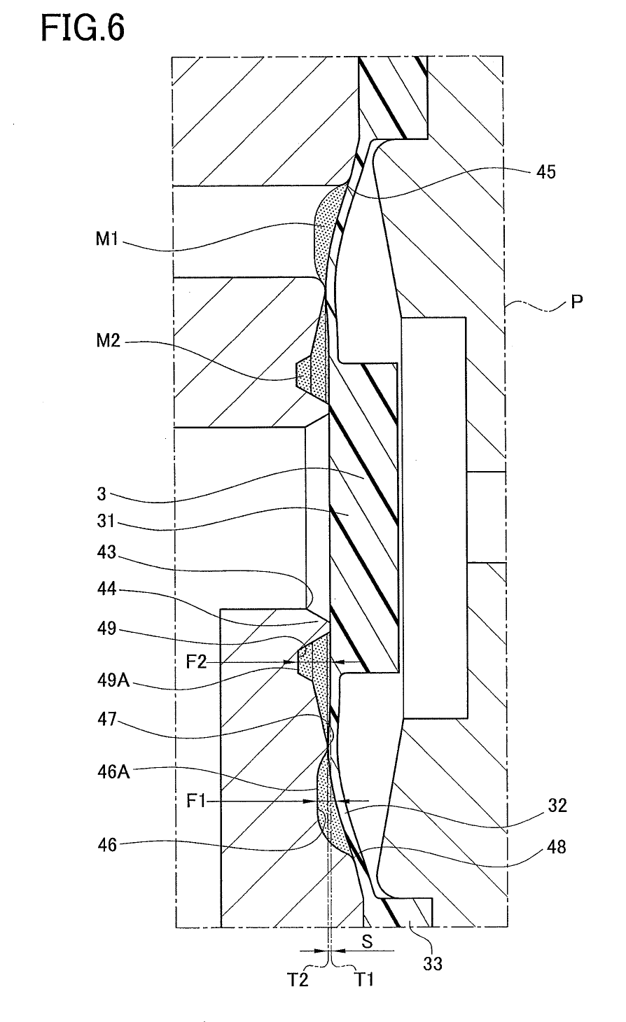

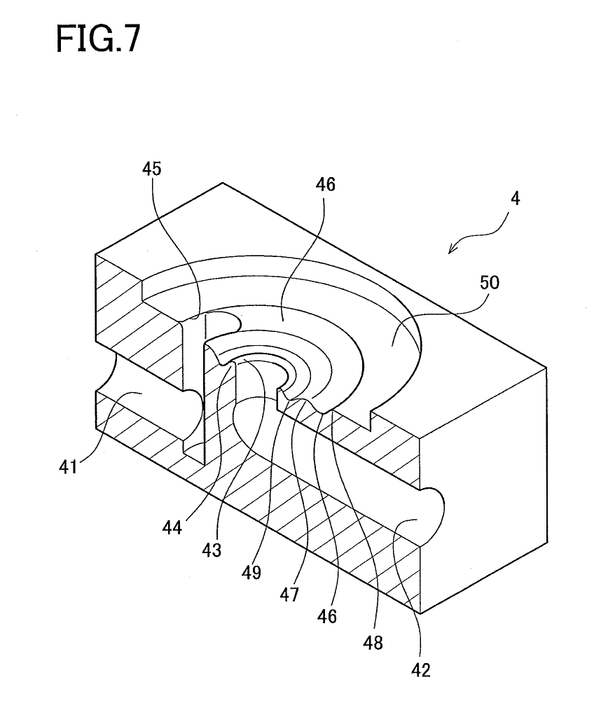

A detailed description of a preferred embodiment of a liquid drip prevention valve embodying the present invention will now be given referring to the accompanying drawings. FIG. 1 is a front view of the liquid drip prevention valve, FIG. 2 is a cross sectional view of the liquid drip prevention valve (a valve open state) taken along a line II-II in FIG. 1, FIG. 3 is a cross sectional view of the liquid drip prevention valve (a valve closed state) taken along the line II-II in FIG. 1, FIG. 4 is a bottom view of the liquid drip prevention valve, FIG. 5 is a top view of the liquid drip prevention valve, FIG. 6 is an enlarged view of a part indicated by a chain line P in FIG. 3, and FIG. 7 is a perspective cross sectional view of a flow passage block.

<Whole Configuration of Liquid Drip Prevention Valve>

As shown in FIG. 2, a liquid drip prevention valve 1 includes an air block 2, a diaphragm valve 3, and a flow passage block 4. The diaphragm valve 3 is held between the air block 2 and the flow passage block 4. The liquid drip prevention valve 1 has a nearly rectangular parallelepiped shape and is formed with an inlet pipe 11 and an output nozzle 12 on opposite sides thereof as shown in FIG. 1. While the liquid drip prevention valve 1 is in a valve open state, a fluid is allowed to flow in the inlet pipe 11 and flow out through the output nozzle 12.

The liquid drip prevention valve 1 consists of three components; the air block 2, the diaphragm valve 3, and the flow passage block 4. This liquid drip prevention valve 1 is therefore small in the number of components, thus enabling size reduction and weight reduction. Since this valve 1 small in the number of components can be simple in structure, furthermore, it can appropriately perform liquid dripping and reliably prevent liquid dripping.

(Configuration of Air Block)

The air block 2 has a nearly rectangular parallelepiped shape and includes an upper face 213 and a lower face 2C which are opposite each other and a contact side face 2A and a non-contact face 2D which are opposite each other, as shown in FIG. 2. The upper face 2B is formed with an air port 21 as shown in FIGS. 2 and 5. This air port 21 will be communicated with, for example, an unillustrated ejector serving as a device for generating negative pressure and an unillustrated compressor serving as a device for applying pressure.

As shown in FIG. 2, the contact side face 2A contacting with the flow passage block 4 is formed with a part of a valve chamber 50. The valve chamber 50 is partitioned by the diaphragm valve 3. In the valve chamber 50, the space defined by a back surface of the diaphragm valve 3 opposite from a surface that will contact with a valve seat 4 is referred to as a back side chamber 23. An airflow passage 22 is bent at right angle in the air block 2 and is communicated with the air port 21 and the back side chamber 23.

(Configuration of Diaphragm Valve Body)

As shown in FIG. 6, the diaphragm valve 3 includes a valve body portion 31 that will contact with the valve seat 44, a retaining portion 33 for fixing the diaphragm valve 3, and a web portion 32 connecting the valve body portion 31 and the retaining portion 33. The valve body portion 31 has a circular disc shape and is surrounded by the web portion 32. Further, the web portion 32 is surrounded by the retaining portion 33.

As shown in FIG. 2, the diaphragm valve 3 is held between the contact side face 2A of the air block 2 and a contact side face 4A of the flow passage block 4 and thus is fixed in the valve chamber 50. The diaphragm valve 3 is configured such that the web portion 32 can be curved and deformed while the retaining portion 33 located on the outer circumference is retained. The valve body portion 31 located on the center is thus movable toward the valve seat 44 or toward back side chamber 23, so that the valve body portion 31 comes into or out of contact with the valve seat 44. The web portion 32 being of a thin diaphragm form can be curved and deformed.

(Configuration of Flow Passage Block)

The flow passage block 4 has a nearly rectangular parallelepiped shape and has an upper face 4B shown in FIG. 5 from which the inlet pipe 11 extends in a vertical direction and a lower face 4C shown in FIG. 4 from which the output nozzle 12 extends in a vertical direction. As shown in FIG. 2, an input port 51 is formed at an end of the input pipe 11. An input passage 41 is formed to extend from the input port 51 to a front side chamber 53. A valve chamber communication port 45 is formed at a communication port through which the input passage 41 is communicated with the front side chamber 53. The valve chamber 50 is partitioned by the diaphragm valve 3. The space defined by a surface of the diaphragm valve 3 that will contact with the valve seat 44 is referred to as the front side chamber 53. The valve chamber 50 includes the front side chamber 53 and the back side chamber 23.

An output port 52 is formed at an end of the output nozzle 12. An output passage 42 is formed to extend from the output port 52 to the front side chamber 53. The output passage 42 is formed in a linear shape with respect to the output port 52. Thus, a fluid having flowed in the front side chamber 53, creating turbulent flow once therein, can be changed into laminar flow in the output passage 42. The length of the output passage 42 is set to an arbitrary size enough to obtain laminar flow of the fluid in the output port 52. This facilitates making the laminar fluid flow. Further, since the output port 52 is formed in the output nozzle 12, the output passage 42 can be adjusted by the length of the nozzle, resulting in reduction in whole weight.

As shown in FIG. 7, the output passage 42 is formed with a circular valve hole 43 at a communication port through which the output passage 42 communicates with the valve chamber 50. The valve seat 44 is formed in a protruding shape in the surrounding area of the valve hole 43 and will contact with the valve body portion 31. An annular diaphragm escape groove 46 is formed in the surrounding area around the valve hole 43 and the valve seat 44 as shown in FIG. 7. The diaphragm escape groove 46 is formed between an annular center-side protrusion 47 and an annular outer-circumferential-side protrusion 48 which are formed around the valve seat 44. The center-side protrusion 47 has a smaller diameter than the outer-circumferential-side protrusion 48 and is located on the center side close to the valve seat 44. A center groove 49 is formed between the center-side protrusion 47 and the valve seat 44. In the diaphragm escape groove 46, the valve chamber communication port 45 is formed as a joining section of the input passage 41 and the valve chamber 50. An opening of this communication port 45 has a shape fitting into between the center-side protrusion 47 and the outer-peripheral-side protrusion 48. Thus, the communication port 45 is included in a part of the diaphragm escape groove 46.

The diaphragm escape groove 46 has a depth F1 so that the web portion 32 does not contact with a bottom 46A of the diaphragm escape groove 46 when the valve body portion 31 of the diaphragm valve 3 contacts with the valve seat 4 as shown in FIG. 6. Thus, when the diaphragm valve 3 comes into contact with the valve seat 44, a gap is inevitably created between the web portion 32 and the diaphragm escape groove 46. Herein, the depth F1 of the bottom 46A represents the distance between a closest point of the web portion 32 to the bottom 46A and the bottom 46A.

On the other hand, the depth F1 of the bottom 46A is preferred to be not too deep. In the present embodiment, the depth F1 of the bottom 46A is set to be shallower than a depth F2 of the bottom 49A of the center groove 49. This is to make the volume M1 (indicated by stippling) of the space of the diaphragm escape groove 46 smaller than the volume M2 (indicated by stippling) of the space of the center groove 49. Specifically, in order to make the spatial volume M1 of the diaphragm escape groove 46 smaller than the spatial volume M2 of the center groove 49, the depth F1 of the bottom 46A is made shallower than the depth F2 of the bottom 49A of the center groove 49. Herein, the depth F2 of the bottom 49A is defined as the distance from a horizontal line T1 of the valve seat face of the valve seat 44 to a farthest point of the center groove 49 from the horizontal line T1.

Since the spatial volume M1 of the diaphragm escape groove 46 is smaller than the spatial volume M2 of the center groove 49, a fluid staying in the diaphragm escape groove 46 is also smaller in amount than in the center groove 49. Accordingly, an amount of the fluid caused to move from the diaphragm escape groove 46 when the diaphragm valve 3 presses the diaphragm escape groove 46 is small. If this moving amount of the fluid is large, the fluid may move toward the valve seat 44 and generates a force in a direction to push up the diaphragm valve 3. If the diaphragm valve 3 is pushed up, the sealing strength of the diaphragm valve 3 with respect to the valve seat 44 is weakened. Furthermore, pressurizing is required to increase the sealing strength by just that much and thus the energy to be used has to be increased. Therefore, the fluid in the diaphragm escape groove 46 is reduced to decrease the moving amount of the fluid, thereby reducing an amount of the fluid leaking to the diaphragm valve 3. This enables maintaining the sealing strength between the diaphragm valve 3 and the valve seat 44.

When the spatial volume M1 of the diaphragm escape groove 46 is smaller than the spatial volume M2 of the center groove 49, the fluid is allowed to move to the larger spatial volume M2 of the center groove 49. In this manner, the moving fluid is allowed to flow into the center groove 49, the fluid does not act as a force to push up the diaphragm valve 3. This makes it possible to keep the sealing strength between the diaphragm valve 3 and the valve seat 44.

However, the spatial volume M1 of the diaphragm escape groove 46 shown in FIG. 6 is determined by the distance between the center-side protrusion 47 and the outer-circumferential-side protrusion 48 in the same radial direction in addition to the depth F1 of the bottom 46A. Similarly, the spatial volume M2 of the center groove 49 is determined by the distance between the valve seat 44 and the center-side protrusion 47 in the same radial direction in addition to the depth F2 of the bottom 49A. Accordingly, since the depth F1 of the bottom 46A is a depth designed to provide the spatial volume M1 of the diaphragm escape groove 46 smaller than the spatial volume M2 of the center groove 49, it is appropriately changed in view of a relationship with the spatial volume M2 of the center groove 49. On the contrary, adjusting the depth F2 of the bottom 49 also enables adjusting the relationship between the spatial volume M1 of the diaphragm escape groove 46 and the spatial volume M2 of the center groove 49. Furthermore, the distance between the center-side protrusion 47 and the outer-circumferential-side protrusion 48 and the distance between the valve seat 44 and the center-side protrusion 47 may be adjusted in view of the relationship between the volume M1 and the volume M2.

As shown in FIG. 6, the height (defined with reference to the bottom face 4D; the same applies to the rest) of the horizontal line T2 (i.e., a diametrical line across the ridge of the circular center-side protrusion 47) of the center-side protrusion 47 is preferred to be lower than the height (defined with reference to the bottom face 4D; the same applies to the rest) of the horizontal line T1 (i.e., a diametrical line across the ridge of the circular valve seat 44) of the valve seat face of the valve seat 44. To be concrete, the horizontal line T1 and the horizontal line T2 are different from each other by a height S. This difference by the height S enables increasing the stress of the diaphragm valve 3 that presses the valve seat 4. This is because the valve body portion 31 of the diaphragm valve 3 comes into contact with the valve seat 44 and then the valve body portion 31 is pulled by the web portion 32, so that pulling the valve body portion 31 by the web portion 32 can enhance the stress on the valve body portion 31.

The flow passage block 4 is made of a chemical-resistant material. Alternatively, the input passage 41, the output passage 42, the valve chamber 50, and others of the flow passage block 4 that will be exposed to the fluid are coated by a chemical-resistant material. Accordingly, even if for example a corrosive fluid is caused to flow through the liquid drip prevention valve 1, the fluid is allowed to flow out without causing contamination.

<Operations and Effects of Liquid Drip Prevention Valve>

A valve open state of the liquid drip prevention valve 1 will be explained. The liquid drip prevention valve 1 shown in FIG. 2 is in a valve open state where the valve body portion 31 of the diaphragm valve 3 is separated from the valve seat 44. In the state shown in FIG. 2, a fluid flowing in the input port 51 passes through the input passage 41, the front side chamber 53, the valve hole 43, and the output passage 42, and then flows out through the output port 52.

To place the liquid drip prevention valve 1 into a valve open state shown in FIG. 2, negative pressure is supplied thereto through the air port 21 from an unillustrated ejector and others. Accordingly, the air in the back side chamber 23 is sucked and discharged out through the air port 21 via the airflow passage 22. As the air in the back side chamber 23 is sucked, also sucking the diaphragm valve 3, the valve body portion 31 is separated from the valve seat 44. In the present embodiment, the negative pressure enables separating the diaphragm valve 3 from the valve seat 44. Thus, the number of components required for valve opening can be reduced. Since the liquid drip prevention valve can be made up of three components; the air block 2, the diaphragm valve 3, and the flow passage block 4, the valve can be reduced in the number of components, thereby enabling size reduction and weight reduction.

A valve closed state of the liquid drip prevention valve 1 will be explained. The liquid drip prevention valve 1 shown in FIG. 2 is pressurized by an unillustrated compressor and others through the air port 21, so that air is filled in the back side chamber 23. When the air is filled in the back side chamber 23, the diaphragm valve 3 is pressed, bringing the valve body portion 31 into contact with the valve seat 44, thus closing the valve hole 43. In the state shown in FIG. 3, therefore, the fluid flowing in the input port 51 is not allowed to flow in the output passage 42 and does not flow out through the output port 52.

(Changes in Stress at the Time of Valve Closing and Valve Opening)

Next, an explanation is given to changes in stress on the diaphragm valve 3 when the liquid drip prevention valve 1 of the present embodiment is used.

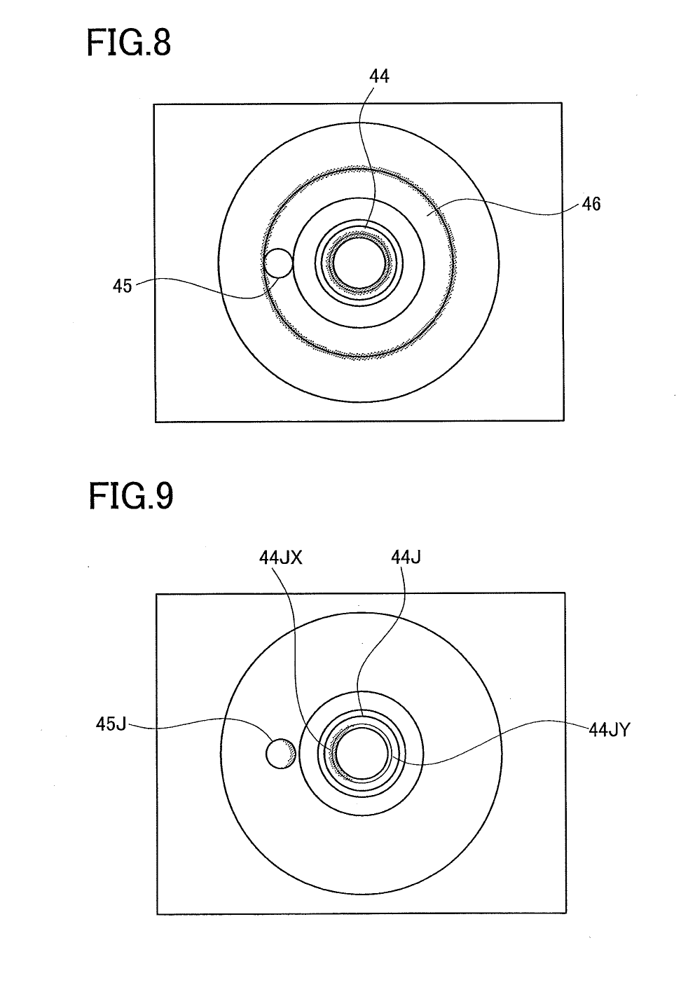

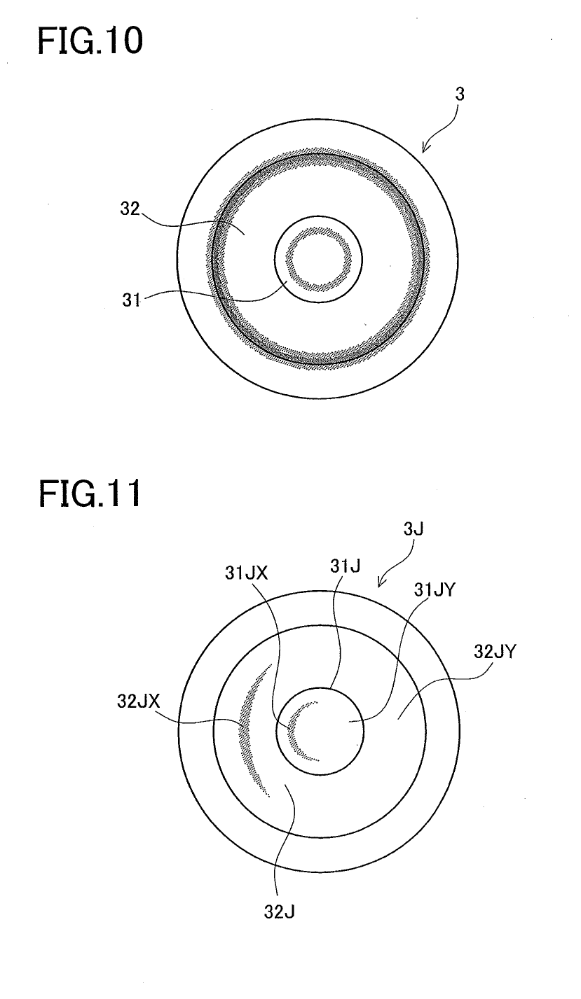

FIG. 8 is a stress distribution diagram of the stress on the valve seat 44 and its surrounding area when the valve chamber 50 of the liquid drip prevention valve 1 (valve closing) is seen in the direction of the air block 2. FIG. 9 is a stress distribution diagram of the stress on a valve seat 44J and its surrounding area when a valve chamber of a liquid drip prevention valve (valve closing) formed with no diaphragm escape groove is seen in the direction of an air block. FIG. 10 is a stress distribution diagram of the stress on the diaphragm valve 3 of the liquid drip prevention valve 1 (valve closing). FIG. 11 is a stress distribution diagram of the stress on a diaphragm valve 37 of the liquid drip prevention valve (valve closing) formed with no diaphragm escape groove. The reference signs assigned to the components of the liquid drip prevention valve in FIGS. 9 and 11 correspond to a combination of the reference signs in the present embodiment and an alphabet “J”. In FIGS. 8 to 11, portions subjected to high stress are illustrated by stippling.

When the liquid drip prevention valve in a related art is used and closed, as shown in FIG. 9, a near portion 447X of the valve seat 44J close to a valve chamber communication port 45J is subjected to high stress. On the contrary, a far portion 45JY far from the communication port 45J is subjected to low stress.

When the liquid drip prevention valve in the related art is used and closed, as shown in FIG. 11, of a valve body portion 31J of the diaphragm valve 3J, a web near portion 32JX located close to and above the communication port 45J is subjected to high stress. On the contrary, a web far portion 32JY located diagonally with respect to the web near portion 32JX is subjected to low stress. Furthermore, a valve-body near portion 317X located close to the communication port 45J is subjected to high stress. On the contrary, a valve-body far portion 31JY located far from the communication port 45J is subjected to low stress.

The reason of the above is in that when air is filled in the back side chamber not shown to close the liquid drip prevention valve, the diaphragm valve 3J is pressed against the communication port 45J which is a space, and thus stress is generated. To be concrete, the diaphragm valve 3J is pressed by the air toward the valve seat 44J. The air will inherently apply pressure uniformly from the back surface of the diaphragm valve 3J. However, in the configuration formed with no diaphragm escape groove 46, the diaphragm valve 3J is pressed against the communication port 45J that is a unique space and thus is subjected to stress. Accordingly, in the diaphragm valve 3J, only a part of the web portion 32J becomes depressed. When the shape of this part of the web portion 32J of the diaphragm valve 3J is changed, a valve body portion 31J contacting with the valve seat 44J will be displaced. Consequently, the configuration formed with no diaphragm escape groove causes displacement of the diaphragm valve 3J from the valve seat 44J and disables making the diaphragm valve 3J contact with the valve seat 44J over the entire circumference with uniform stress. Thus, the sealing force becomes nonuniform over the entire circumference of the valve seat 447, generating some weakly sealed portions. Fluid leakage is caused at the weakly sealed portion(s), liquid dripping is not reliably prevented.

On the other hand, when the liquid drip prevention valve 1 of the present embodiment shown in FIG. 8 is used and closed, the valve seat 44 is subjected to high stress uniformly over the entire circumference. As shown in FIG. 10, furthermore, the valve body portion 31 and the web portion 32 of the diaphragm valve 3 are similarly uniformly subjected to high stress. Stress uniformly exerted on the valve seat 44 and the valve body portion 31 enables increasing the sealing strength and thus surely preventing liquid dripping.

In the present embodiment, the diaphragm escape groove 46 is formed in an annular form extending over the entire circumference. Accordingly, the shape of the diaphragm valve 3 is uniformly deformed over the entire circumference as with the shape of the diaphragm escape groove 46. Since the shape is uniformly changed over the entire circumference, the diaphragm valve 3 can be prevented from becoming displaced from the contact face of the valve seat 44. Thus, the diaphragm valve 3 can be placed in contact with the valve seat 44 over the entire circumference with uniform stress, thereby ensuring reliably preventing liquid dripping.

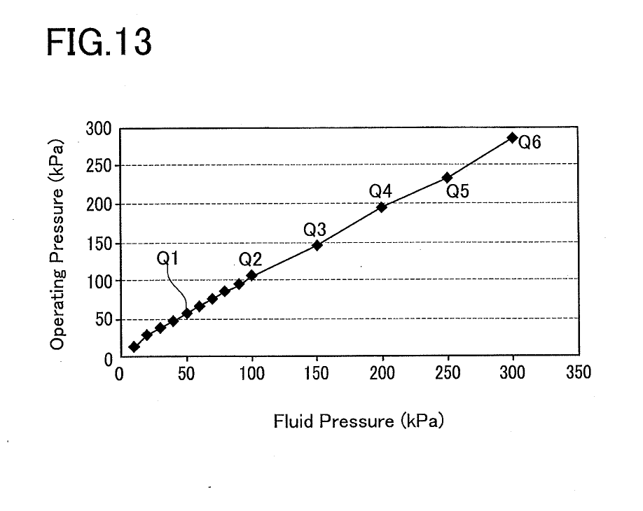

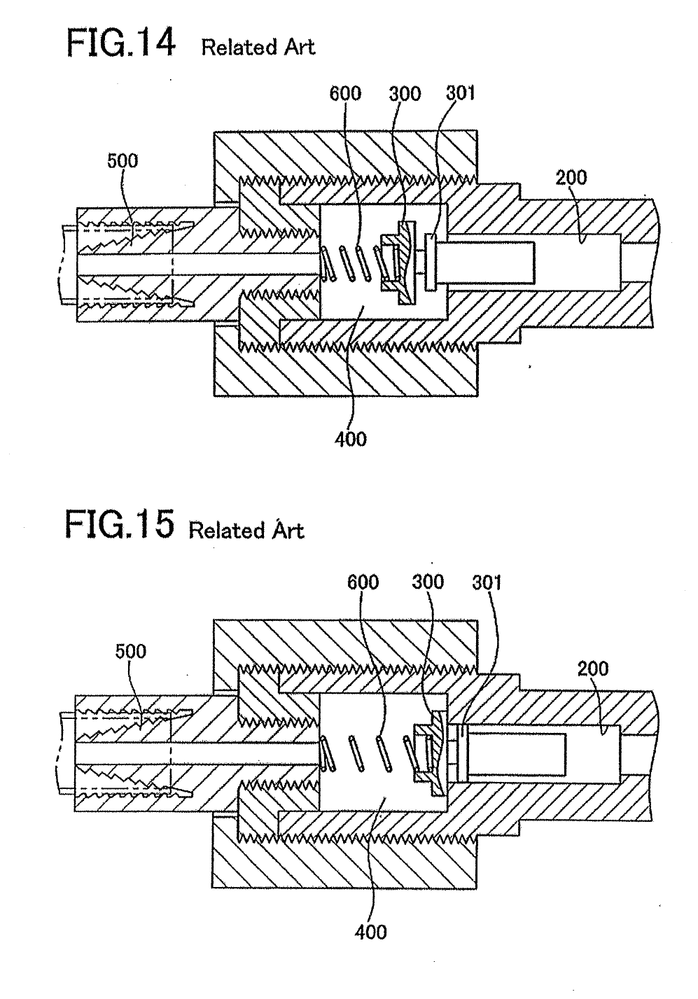

FIG. 13 is a graph showing a relationship between operating pressure and fluid pressure in the liquid drip prevention valve 1. In the present embodiment formed with the diaphragm escape groove 46, the stress can be exerted uniformly on the valve seat 44 and the valve body portion 31 and thus the sealing strength can be enhanced. This makes it possible to reliably seal even when the operating pressure is set small, and prevent liquid dripping. Since the diaphragm escape groove 46 is formed, a fluid in this groove 46 will be of help to push up the diaphragm valve 3 in a valve opening direction at the time of valve opening. Owing to the presence of the diaphragm escape groove 46, therefore, valve opening can be performed under a small negative pressure.

To be concrete, as shown in FIG. 13, at Q1 for a 50-kPa fluid pressure, the operating pressure can be set to about 60 kPa. At Q2 for a 100-kPa fluid pressure, the operating pressure can be set to about 110 kPa. At Q3 for a 150-kPa fluid pressure, the operating pressure can be set to about 150 kPa. At Q4 for a 200-kPa fluid pressure, the operating pressure can be set to about 200 kPa. At Q5 for a 250-kPa fluid pressure, the operating pressure can be set to about 230 kPa. At Q6 for a 300-kPa fluid pressure, the operating pressure can be set to about 280 kPa. When the liquid drip prevention valve formed with no diaphragm escape groove is used, it needed an operating pressure than the liquid drip prevention valve 1 of the present embodiment. From the above results, as compared with the liquid drip prevention valve formed with no diaphragm escape groove, the liquid drip prevention valve 1 formed with the diaphragm escape groove 46 can be operated under a smaller operating pressure.

(Motion of Fluid in Flow Passage)

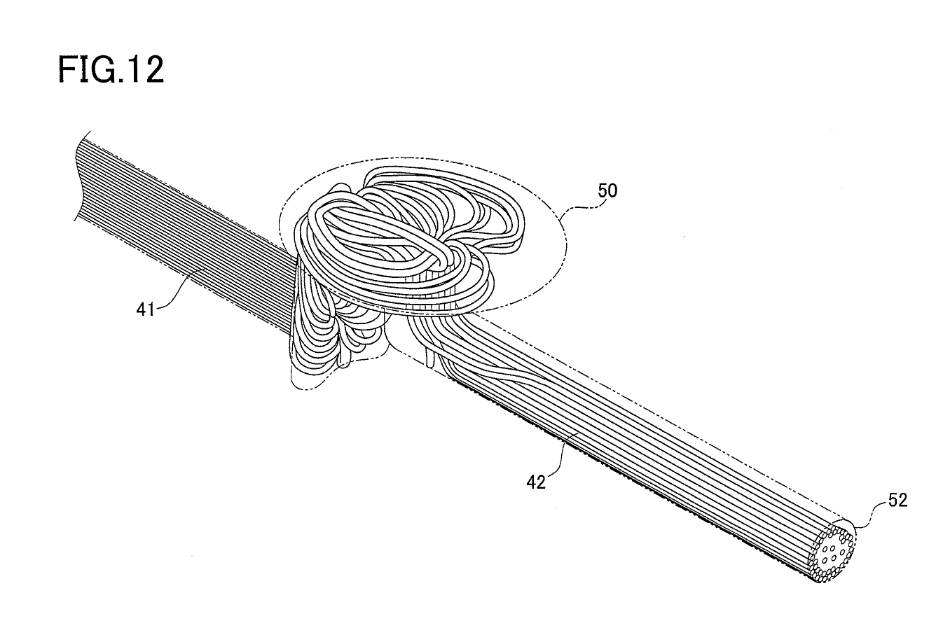

Next, an explanation will be given to the flow of a fluid flowing in the output passage 42 and flowing out from the output port 52 of the liquid drip prevention valve 1 of the present embodiment. FIG. 12 is a flow line diagram in the liquid drip prevention valve shown in FIG. 2.

As shown in the flow line diagram of FIG. 12, flow lines flowing through the input passage 41 are linear before entering the valve chamber 50 and thus the fluid flows straight. Successively, the fluid having flowed in the valve chamber 50 impinges on the inner wall surface of the valve chamber 50, causing turbulent flow, resulting in complicated flow lines. However, the flow lines having flowed from the valve chamber 50 into the output passage 42 come to turbulent flow but laminar flow extending straight until the fluid flows out from the output port 52. This laminar flow is formed because the output passage 42 extends in a linear form up to the output port 52. The length of the output passage 42 is arbitrarily designed to be so long as to attain the laminar flow of the fluid in the output port 52. Thus, the laminar flow of the fluid can be made easy and the flow lines are linear as shown in FIG. 12.

The present invention is not limited to the above embodiment and may be embodied in other specific forms without departing from the essential characteristics thereof.

For instance, in the present embodiment, the web portion 32 of the diaphragm valve 3 is illustrated as a uniformly thin sheet form, but a part of the web portion 32 which will contact with the center-side protrusion 47 may be formed thick. When this portion which will contact with the center-side protrusion 47 is formed thick, durability can be enhanced.

In the present embodiment, for instance, the flow passage block 4 is shown as being rectangular parallelepiped, but may be formed in a nearly cylindrical shape in which only a surface contacting with the air block 2 is flat. Specifically, the shape of the flow passage block 4 is not limited to the rectangular parallelepiped shape and may be selected from any shapes such as the nearly cylindrical shape as long as it has a flat surface that contacts with the air block 2.

In the present embodiment, for instance, there is disclosed that the fluid flows in the input passage and flows out from the discharge flow passage. Alternatively, the liquid drip prevention valve 1 shown in FIGS. 2 and 3 may be used in a reversed orientation to invert the direction of a fluid flow. At that time, the input passage and the output passage are reversed, so that the input pipe 11 operates as an output nozzle and the nozzle 12 operates as an input pipe.

For instance, the liquid drip prevention valve 1 of the present embodiment may be installed in a manifold base. Accordingly, this installation of the liquid drip prevention valve 1 can achieve space saving. Since this installation in the manifold base can be made in a retrofit manner, replacement is easy. When the liquid drip prevention valve 1 is to be joined to the manifold base, for example, the liquid drip prevention valve 1 may be joined in series thereto. As an alternative, a circumferential joining may be adopted.

For instance, the liquid drip prevention valves 1 of the present embodiment may be assembled to constitute a manifold base. This manifold base consisting of the assembled liquid drip prevention valves 1 can provide the same operations and effects as with the liquid drip prevention valve 1 of the present embodiment. Furthermore, the manifold base may be configured to include the liquid drip prevention valve 1 and other fluid control valves and so on.

For instance, the liquid drip prevention valve may be configured as a manifold form. To be concrete, this manifold form can be achieved by including a plurality of liquid drip prevention valves including a plurality of input passages, a plurality of output passages, a plurality of valve chambers, a plurality of valve holes, and a plurality of valve seats in flow passage blocks, a plurality of airflow passages in air blocks, and a diaphragm valve corresponding to a plurality of valve seats. Such a manifold form can achieve space saving while providing the inherent operations and effects of the liquid drip prevention valve of the present embodiment.

### REFERENCE SIGNS LIST

1 Liquid drip prevention valve
2 Air block
22 Airflow passage
23 Back side chamber
3 Diaphragm valve
4 Flow passage block
4A Contact side face
4B Upper face
4C Lower face
41 Input flow passage
42 Output flow passage
43 Valve hole
44 Valve seat
50 Valve chamber
51 Input port
52 Output port

1. A liquid drip prevention valve comprising: a flow passage block including an input passage, an output passage, and a valve chamber with which the input passage and the output passage are communicated, the flow passage block being formed with a valve seat around a valve hole communicated with the output passage in the valve chamber;
an air block formed with an airflow passage; and a diaphragm valve fixed between the flow passage block and the air block to move into or out of contact with the valve seat, wherein
the flow passage block is formed, on an upper face, with an input port communicated with the input passage,
the flow passage block is formed, on a lower face opposite the upper face, with an output port communicated with the output passage,
the valve chamber is formed in a side face of the flow passage block and the air block is in contact with the side face, and
the diaphragm valve will come into contact with the valve seat when a back side chamber of the diaphragm valve is pressurized and will separate from the valve seat when the back side chamber is subjected to negative pressure.

2. The liquid drip prevention valve according to claim 1,
wherein a diaphragm escape groove is formed around the valve seat,
the diaphragm escape groove is formed in an annular form around the valve hole, and
a valve chamber communication port is formed in the diaphragm escape groove to provide communication between the input passage and the valve chamber.

3. The liquid drip prevention valve according to claim 2, wherein the diaphragm escape groove has a depth so that a web portion of the diaphragm valve will not contact with a bottom of the diaphragm escape groove when the diaphragm valve is placed into contact with the valve seat.

4. The liquid drip prevention valve according to claim 2, wherein the diaphragm escape groove is formed between a center-side protrusion formed in an annular form around the valve seat and an outer-circumferential-side protrusion formed in an annular form, and
the center-side protrusion is lower than a valve seat face.

5. The liquid drip prevention valve according to claim 2, wherein the diaphragm escape groove is formed so that the diaphragm valve is allowed to contact with the valve seat over an entire circumference by uniform stress.

6. The liquid drip prevention valve according to claim 1, wherein the input passage, the output passage, and the valve chamber are made of a chemical-resistant material or are coated by a chemical-resistant material.

7. The liquid drip prevention valve according to claim 1, wherein the output passage has a length enough to obtain laminar flow of the fluid in the output port.

8. The liquid drip prevention valve according to claim 1, wherein the output port is formed in an output nozzle.

9. The liquid drip prevention valve according to claim 1 will be placed on a manifold base.

10. The liquid drip prevention valve according to claim 1, wherein
the flow passage block includes a plurality of input passages, a plurality of output passages, a plurality of valve chambers, a plurality of valve holes, and a plurality of valve seats,
the air block includes a plurality of airflow passages, and
a plurality of the diaphragm valve bodies are provided in correspondence to the plurality of valve seats.

11. The liquid drip prevention valve according to claim 3, wherein the diaphragm escape groove is formed between a center-side protrusion formed in an annular form around the valve seat and an outer-circumferential-side protrusion formed in an annular form, and
the center-side protrusion is lower than a valve seat face.

12. The liquid drip prevention valve according to claim 3, wherein the diaphragm escape groove is formed so that the diaphragm valve is allowed to contact with the valve seat over an entire circumference by uniform stress.

13. The liquid drip prevention valve according to claim 4, wherein the diaphragm escape groove is formed so that the diaphragm valve is allowed to contact with the valve seat over an entire circumference by uniform stress.

14. The liquid drip prevention valve according to claim 11, wherein the diaphragm escape groove is formed so that the diaphragm valve is allowed to contact with the valve seat over an entire circumference by uniform stress.
